(19) United States
(12) Patent Application Publication
(10) Pub. No.: US 2011/0090520 A1
(43) Pub. Date: Apr. 21, 2011

(54) IMAGE PROCESSING APPARATUS AND CONTROL METHOD THEREOF

(75) Inventors: Masanori Yokoi, Yokohama-shi (JP); Koji Harada, Yokohama-shi (JP); Junichi Hayashi, Kamakura-shi (JP)

(73) Assignee: CANON KABUSHIKI KAISHA, Tokyo (JP)

(21) Appl. No.: 12/892,685

(22) Filed: Sep. 28, 2010

(30) Foreign Application Priority Data
Oct. 20, 2009 (JP) 2009-241889
Jul. 27, 2010 (JP) 2010-168428

(51) Int. Cl. H04N 1/60

(52) U.S. Cl. 358/1.9

(57) ABSTRACT

An image processing apparatus for generating a print image which can be easily visually recognizable under a particular light source, without using special ink, by utilizing a characteristic of a print medium. A color information holding unit holds first color information and second color information indicating different ink use amounts in a print unit per unit area on a print medium, and a color difference equal to or less than a predetermined value under ordinary light. In accordance with a value of a pixel of binary latent image data delivered from a latent image generator, a discrimination image data generator print-outputs one of the first color information and the second color information as print data with respect to the pixel.

### BACKGROUND OF THE INVENTION

1. Field of the Invention

The present invention relates to a technique for generating image data to visualize a mark, character(s) or the like on a print medium under a particular light source.

2. Description of the Related Art

As an anticounterfeit technology or authenticity check technology for printed matter, a printing method using special ink that cannot be visually observed (or observed with difficulty) under ordinary light but can be easily visually observed under a particular light source is known. As a typical method, a method of printing an image on a print medium with a printing device using ink including fluorescent dye, irradiating ultraviolet light on the outputted printed matter, thereby generating an image with fluorescence is known (for example, see Japanese Patent Laid-Open No. 9-227817).

However, when special ink as described above is used, it is necessary to provide an ink tank for the special ink in the device. Further, after generation of printed matter by printing using normal ink on a print medium, it is necessary to perform another process of printing. This takes a lot of trouble. Since printing is performed twice, it is necessary to perform positioning of the image formed with the special ink with respect to the image on the printed matter formed with the normal ink.

### SUMMARY OF THE INVENTION

The present invention has been made to address the above-described problems, and provides a technique for generating a print image which can be easily visually observed under a particular light source, utilizing a characteristic of a print medium, without particular printing material such as ink or toner.

To attain this object, the present invention provides an image processing apparatus having e.g. the following structure. That is, provided is an image processing apparatus for outputting print image data to a printing device which performs printing by attaching ink to a print medium, comprising: a color information holding unit configured to hold first color information and second color information indicating different ink use amounts in the printing device per unit area on the print medium, and a color difference under ordinary light equal to or less than a predetermined threshold value, an input unit configured to input discrimination subject information, a generation unit configured to generate binary latent image data in accordance with the input discrimination subject information, and an output unit configured to, in correspondence with a value of each pixel of the latent image data generated by the generation unit, output one of the first color information and the second color information held in the color information holding unit, as print data with respect to the pixel, to the printing device.

According to the present invention, by utilizing e.g. the fact that a fluorescent brightening agent which becomes fluorescent under ultraviolet light is included in a normal print sheet, print image data which cannot be discriminated under ordinary light but can be discriminated under particular light (under ultraviolet light in this case) can be generated.

Further features of the present invention will become apparent from the following description of exemplary embodiments with reference to the attached drawings.

### BRIEF DESCRIPTION OF THE DRAWINGS

FIGS. 1A and 1B are block diagrams showing principal functional configurations of an image processing apparatus in embodiments of the present invention;

FIG. 2 is a flowchart showing discrimination image generation processing in the embodiment;

FIG. 3 is a flowchart showing the discrimination image generation processing in the embodiment;

FIGS. 4A and 4B show the conception of a discrimination image;

FIG. 5 is a graph showing the degrees of fluorescence with respect to changes of ink use amount;

FIGS. 6A to 6D are graphs showing by example processing of determination of color information on a second color;

FIGS. 7A to 7C illustrate by example latent image data;

FIGS. 8A to 8D illustrate by example a color information table;

FIG. 9 is a block diagram showing a basic configuration of a computer system in the embodiment;

FIG. 10A illustrates by example a ticket;

FIG. 10B is a flowchart showing an application program for generating a ticket;

FIG. 11 is a flowchart showing processing in a printer driver;

FIGS. 12A and 12B are block diagrams showing principal functional configuration of the image processing apparatus in a third embodiment of the present invention;

FIG. 13 is a flowchart showing the discrimination image generation processing in the second embodiment;

FIG. 14 is a flowchart showing the color information generation processing in the second embodiment;

FIGS. 15A and 15B illustrate by example color measurement data showing relation between the ink use amount and color space data;

FIG. 16 illustrates by example the color space data; and

FIG. 17 is a table showing by example covering ratio data showing relation between the ink use amount and covering ratio.

### DESCRIPTION OF THE EMBODIMENTS

Hereinbelow, preferred embodiments of the present invention will be described in detail in accordance with the accompanying drawings.

### First Embodiment

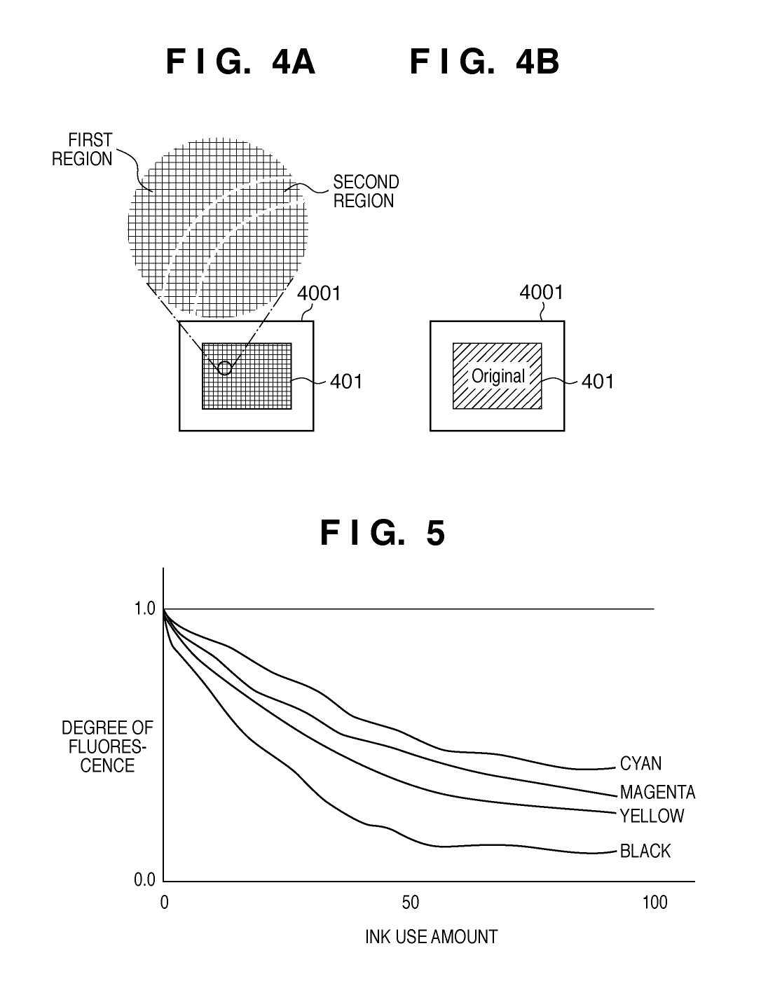

First, the basic conception of the present embodiment will be briefly described using FIGS. 4A and 4B. Printed matter 4001 has a discrimination image 401 (in FIG. 4B, a region of characters “Original” and its background region). In the discrimination image 401, the region of the character(s) (or mark) which cannot be recognized as shown in FIG. 4A under ordinary light (e.g., color measurement light D50 with relative spectral distribution regulated by e.g. CIE (Commission Internationale de l'Eclairage:International Commission on Illumination) (in the figure, the border lines are drawn for assistance of understanding), but can be visualized as shown in FIG. 4B under a particular light source (for example, ultraviolet light). With this arrangement, as authenticity check, when the character(s) (or mark) can be recognized in the printed matter under ultraviolet light, it is determined that the printed matter is a real, otherwise, it is determined that the printed matter is a forgery.

In many cases, a general print sheet (hereinbelow, “print medium”) includes, with some minor difference in content, a fluorescent brightening agent to maintain whiteness to some degree. It is known that the fluorescent brightening agent becomes fluorescent under ultraviolet light (so-called black light). More particularly, the fluorescent brightening agent has a characteristic in that it absorbs ultraviolet light (wavelength: 300 to 400 nm) and changes the absorbed ultraviolet light to blue visible light (wavelength: 400 to 450 nm) and radiates the visible light (this operation is called “fluorescence”). Accordingly, when a sheet including the fluorescent brightening agent (not limited to paper) is irradiated with ultraviolet light, it is fluorescent in pale blue.

Printing on a print medium at last means attaching printing color material to the print medium, i.e., covering the print medium with the attached printing material. Accordingly, when a comparison is made between a region where the printing color material is attached to many points with a region where the printing color material is attached to fewer points, as the ratio of exposed surface of the print medium is higher in the latter region, the degree of fluorescence under ultraviolet light is higher. In other words, when regions are intentionally generated in which the printing color material is attached per unit area (hereinbelow, “covering ratio”) are different, regions having different degrees of fluorescence under ultraviolet light can be generated.

Note that as the printing color material, ink (pigment ink or dye ink) and toner may be used, and different printing methods are used for these materials having different characteristics. When the printing color material is toner, toner particles as solid materials are attached to a drum, then transferred to paper and fixed to the paper. Then, to reproduce the tonality of a color of a print image, the area dot percentage per unit area is changed. With this arrangement, the toner can be easily fixed to a desired position, and further, as the toner particles are solid materials, there is no probability of blur. Accordingly, the intentional generation of regions with different covering ratio can be comparatively easily realized.

On the other hand, when the printing color material is ink, liquid ink droplets are discharged from nozzles and attached to paper. To reproduce the tonality of a color of a print image, an ink use amount per unit area is changed. With this arrangement, it is difficult to attach the ink to a desired position and there is a probability of overlapped ink discharge. Further, as the ink is in liquid state, blur occurs on the paper, and there is a probability that the shape of the attached ink is not constant. Accordingly, with the above-described two factors, it is difficult to intentionally generate regions with different covering ratios.

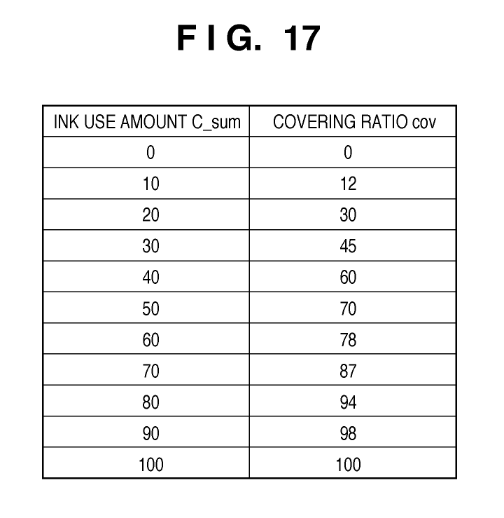

As described above, in a case where the printing color material is ink, although it is difficult to directly control the covering ratio by using the relation between the ink use amount and the covering ratio, in the present embodiment, the covering ratio is indirectly changed by controlling the ink use amount. FIG. 17 is a table showing covering ratios with respect to the ink use amounts. In the present method, a discrimination image is generated by utilizing this relation. With this arrangement, generation of discrimination image in consideration of ink characteristics (overlap, blur and the like) is possible.

FIG. 5 is a graph showing the degrees of fluorescence with respect to the changes of ink use amount per unit area in the respective single color inks (cyan, magenta, yellow and black). This graph is obtained by printing plural measurement patches, where the ink use amount per unit area is changed by single ink, on a print medium including comparatively large amount of fluorescent brightening agent, and forming the graph of figures by measuring luminance in an ultraviolet-light irradiated environment. It is understood from this graph that the degrees of fluorescence are different even with the same ink use amount in accordance with type of single color ink. Further, it is understood that the more the ink use amount becomes, the lower the degree of fluorescence becomes regardless of ink type of single color ink.

As it is apparent from FIG. 5, there are two factors for change of the degree of fluorescence. One factor is the ink use amount. The large the ink use amount becomes, the larger the area of print medium coated with the ink becomes. That is, the ink use amount indirectly represents the ratio of covering the print medium. The other factor is ink color (color component type).

Next, changing the degree of fluorescence can be considered by utilizing the second factor, the difference in suppression power in accordance with ink color type, by performing printing with ink to, e.g., slightly suppress fluorescence in a first region on the print medium and with ink to greatly suppress fluorescence in a second region. However, as it is necessary to use a color material to greatly suppress fluorescence as the second color, there is a probability that the color reproduction range of the second color is limited.

The present inventors have focused attention to the above points, and have made it difficult to discriminate two regions, a first region (character background portion) and a second region (character portion), under ordinary light, as shown in FIG. 4A, while made it possible to easily discriminate these two regions under ultraviolet light as follows.

In the first region and second region, the ink use amount is controlled so as to approximate the colors to each other under ordinary light.

Between the first region and the second region, the ink use amount is controlled such that the ratios of covering with ink are different.

<Color Information Generation Method>

First, the color information generation method will be described. The color information is structural information indicating the amounts of color ink for image formation on a print medium with respect to RGB values of image data. Generally, one color information is determined with respect to one RGB value, and held in a color information table or the like in an output device, a printer driver or the like.

Note that the ratio of each color ink with respect to each RGB value is indicated with a numerical value on the assumption of the amount to fully cover a unit area on the print medium as “100”. In the present embodiment, when the first region indicated in the color information table held at normal times is the first color, the second color used for the second region to satisfy the following condition is determined with respect to the first color. Note that in the following description, L*a*b* color space is used, however, the color space used for color discrimination is not limited to this color space.
With respect to color difference under ordinary light:

ΔEab*={(L1*−L2*)²+(a1*−a2*)²+(b1*−b2*)²}^{1/2}≦Th1
With respect to ink use amount:

ΔC_sum=|C_sum2−C_sum1|Th2 or

C_sum2≧Th4

In the above expression, L* indicates luminance; and a*b*, chromaticity representing color hue and chromaticness. The luminance and chromaticity of the first color is L1* and a1*b1*, and the luminance and chromaticity of the second color, L2* and a2*b2*. Further, the total ink use amount for the first color is C_sum1, and the total ink use amount for the second color, C_sum2. Note that Th1 is a threshold value of color difference undiscriminable for human. Generally, it is said that when the threshold value is equal to or less than 6.5, it is within an allowable range, and when the threshold value is equal to or less than 3.2, the difference is almost recognizable. Further, assuming that the difference in covering ratio as a luminance difference discriminable for human under ultraviolet light is Th3, the threshold value Th2 is a threshold value of the total difference in the ink use amounts for the first color and the second color when the difference covering ratio is Th3. Further, the threshold value Th4 is a threshold value of the total ink use amount for the second color when the covering ratio difference is Th3. These values are not general numerical values, and different in accordance with print medium. Accordingly, it may be arranged such that plural measurement patches with various ink use amounts are printed on a print medium and the threshold values are respectively determined based on difference in covering ratio which is a luminance difference discriminable under ultraviolet light. Further, the ordinary light means light for color measurement with relative spectral distribution regulated by CIE (Commission Internationale de l'Eclairage: International Commission on Illumination). For example, as the ordinary light, D65, D50, A light source, C light source or the like can be given. The second color may be obtained based on the threshold value Th2 as the threshold value of the total difference in ink use amount, or may be obtained based on the threshold value Th4 as the threshold value of the total ink use amount.

Hereinbelow, printing of the first region and the second region will be described in a case where (1) printing is performed using the same ink and in a case where (2) printing is performed using combined different color inks.

(1) Printing with Same Ink

In this case, pixels within a region of image data uniformly have the same color, and with respect to a pixel value Np1 (RGB value), C1=(c,m,y,k)=(0,0,0,24) holds as print color information C1 on the first color.

A region having the first color is formed on paper based on the color information C1, and L*a*b* value measurement is performed under ordinary light (D50). Similarly, candidate colors C21=(0,0,0,18), C22=(0,0,0,30), . . . for the second color, different from the first color, are formed on the print medium, and respective L*a*b* values are measured.

It is assumed as a result of measurement that as the L*a*b* values of the first color, L*=67.77, a*=2.33, and b*=0.18 hold, and the L*a*b* values for the candidate colors C21, C22, . . . ,

$$C 21 ( 0 , 0 , 0 , 30 ) \text{:} {L}^{*} = 62.28 , {a}^{*} = 2.49 , {b}^{*} = 1.54$$

$$C 22 ( 0 , 0 , 0 , 18 ) \text{:} {L}^{*} = 74.11 , {a}^{*} = 2.11 , {b}^{*} = - 1.41$$

$$⋮$$

At this time, as the total ink use amount C_sum, C_sum1=24, C_sum21=30, and C_sum22=18, . . . hold.

Note that as the color difference threshold value, Th1=6.5 holds, and as the threshold value of the total difference in ink use amount, Th2=6 holds. Note that the threshold value of the total difference in ink use amount is obtained by printing plural measurement patches with various ink use amounts on the paper, previously measuring covering ratios of the respective measurement patches, and calculating total differences in ink use amount based on the covering ratio difference as a luminance difference recognizable under ultraviolet light.

In the above case, as a second color candidate, a value satisfying the color difference ΔEab* with respect to the first color equal to or less than the threshold value (ΔEab*≦6.5), when ΔC_sum≧6 holds as the total difference in ink use amount ΔC_sum, is found. It is desirable that the difference ΔEab* is as small as possible, and the total difference in ink use amount ΔC_sum, as large as possible.

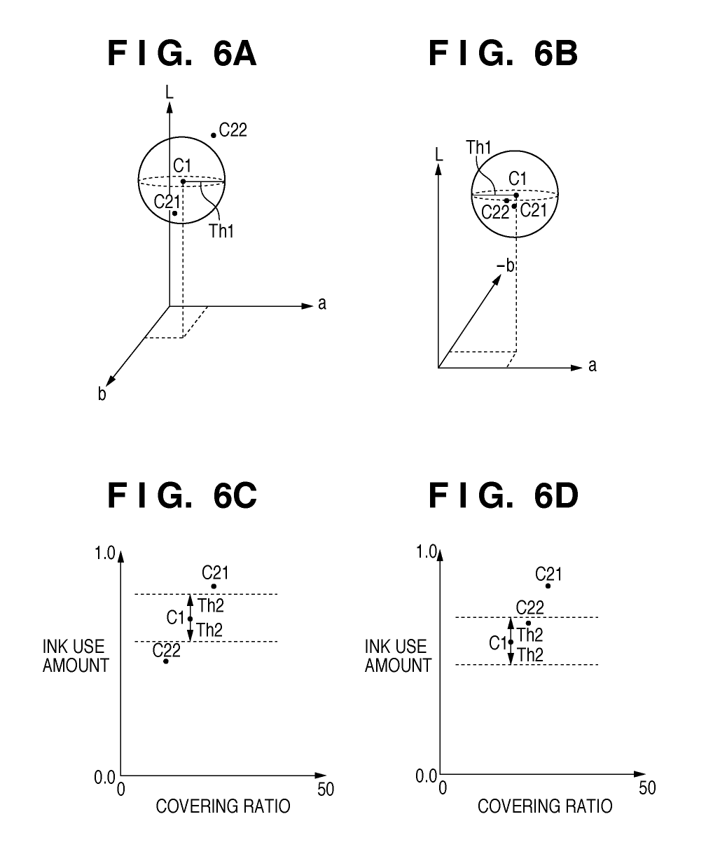

FIG. 6A illustrates respective color L*a*b* values (two second color candidates in FIG. 6A), and FIG. 6C, the total ink use amount C_sum. In the figures, dotted lines indicate the threshold values Th1 and Th2, and the second color is within the range indicated with the dotted lines in FIG. 6A and without the dotted lines in FIG. 6C.

As a result of calculation, as the color difference between C21(0,0,0,30) and C1, ΔEab*=5.66 holds, and ΔC_sum=|C_sum1−C_sum21|=|24−30|=6 holds. Further, as the color difference between C22(0,0,0,18) and C1, ΔEab*=6.55 holds, and ΔC_sum=|C_sum1−C_sum2|=|24−18|=6 holds.

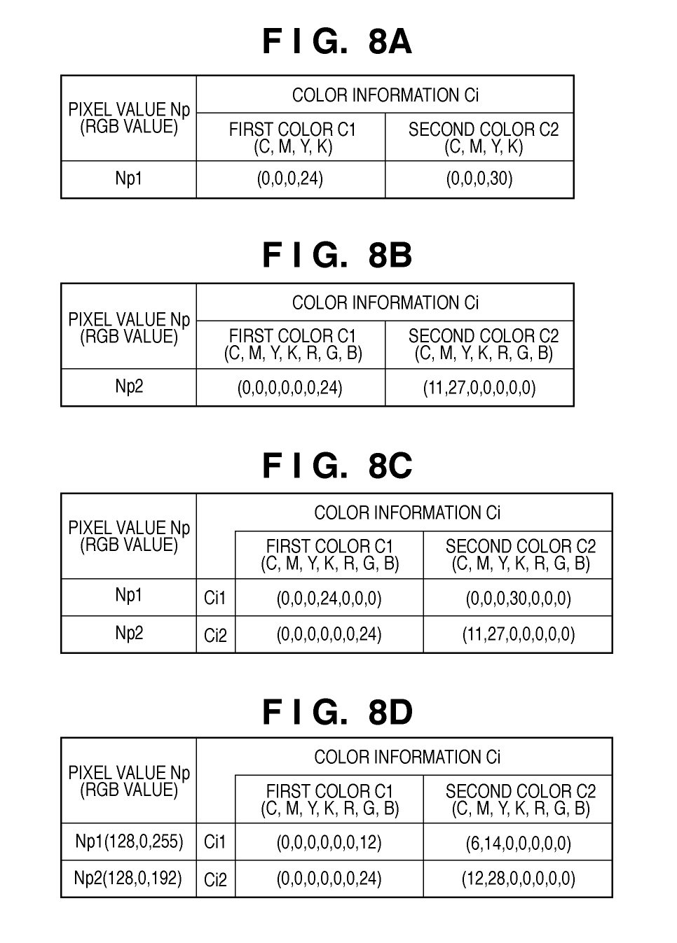

Accordingly, as the color information C2 for the second color, C2=C21=(0,0,0,30) is determined as a color satisfying the above conditions. Accordingly, C1=(c,m,y,k)=(0,0,0,24) is determined as the color information with respect to the pixel value Np1 in the first region, for the first color, C2=(c,m,y,k)=(0,0,0,30) is determined as the color information on the second color in the second region, and the color information table as shown in FIG. 8A is generated.

(2) Printing with Different Inks

When the ink type is other than cyan(c), magenta (m), yellow (y) and black (k), e.g., red (r), green (g) and blue (b) (used in certain types of printing devices for business use), the second color different from the first color can be defined as many types. For example, red can be reproduced with combination of magenta and yellow. Further, green can be reproduced with combination of cyan and yellow, and blue, with combination of cyan and magenta.

In the following description, as an example, the first color is represented with blue, and the second color, with combination of cyan and magenta.

Assuming that with respect to a pixel value Np2 (RGB value) of image data, as the color information C1 on the first color,

C1=(c,m,y,k,r,g,b)=(0,0,0,0,0,0,24) holds, the first color image is formed on paper based on the color information C1, and measurement of L*a*b* values is performed under the ordinary light (D50).

Next, with the two cyan and magenta inks, the second color candidates C21=(11,27,0,0,0,0,0) and C22=(9,25,0,0,0,0,0) . . . are formed on paper, and the L*a*b* values are measured. In this example, as a result, as the L*a*b* values of the first color, L*=72.15, a*=24.60, and b*=−35.96 hold. As the L*a*b* values of the candidate colors,

C21(11,27,0,0,0,0,0): L*=70.17, a*=24.92 and b*=−32.90 hold, and
C22(9,25,0,0,0,0,0): L*=72.48, a*=24.47 and b*=−30.54 hold.

At this time, as the total ink use amount C_sum, C_sum1=24, C_sum21=38 and C_sum22=34 hold.

Next, assuming that as the threshold, Th1=6.5 and Th2=12 hold, the second color is found as a color when, as the color difference and the luminance difference with respect to the first color, color difference ΔEab*≦6.5 and the total difference in ink use amount ΔC_sum≧12 hold.

FIG. 6B shows the L*a*b* values of the respective colors, and FIG. 6D, the total C_sum of ink use amount. In the figures, the dotted lines indicate the threshold values Th1 and Th2, and the second color is within the range of the dotted line in FIG. 6B and without the range of the dotted lines in FIG. 6D.

As a result of calculation, as the color difference between C21(11,27,0,0,0,0,0) and C1, ΔEab*=3.66 holds and as the total difference in ink use amount, ΔC_sum=14 holds. Further, as the color difference between C22(9,25,0,0,0,0,0) and C1, ΔEab*=5.4 holds and as the total difference in ink use amount, ΔC_sum=10 holds.

Accordingly, C21=(11,27,0,0,0,0,0) satisfying the above conditions is determined as the color information C2 on the second color. Regarding the color information with respect to the pixel value Np2, as the first color,

C1=(c,m,y,k,r,g,b)=(0,0,0,0,0,0,24) holds, as the second color, C2=(c,m,y,k,r,g,b)=(11,27,0,0,0,0,0) holds, and the color information table as shown in FIG. 8B is generated.

In this manner, with respect to the pixel value Np (RGB value) of image data, the data for the first color and the second color are generated.

Note that in this example, for the sake of simplicity of explanation, the color information tables shown in FIGS. 8A and 8B show color information with respect to only one pixel value, however, color information may be provided respectively with respect to plural pixel values. Further, regarding the color information, generally the color information shown in the color information table held in an output device, a driver or the like is the color information on the first color, and the second color satisfying conditions with respect to the first color is determined. However, the present invention is not limited to this arrangement. It may be arranged such that two colors, with the color information shown in the stored color information table as a reference color, approximate to the reference color and satisfying the above-described conditions, may be determined as the first color and the second color.

Further, in this example, the above-described color information generation is performed by utilizing the difference in ink use amount per unit area as one of the factors for changes of the degree of fluorescence. However, the present invention is not limited to this arrangement. It may be arranged such that the color information generation is performed by utilizing the power of color material to suppress fluorescence as another factor. In this case, as the two factors are utilized, in comparison with the case using only one factor, the range of color reproduction is further expanded, and the present method is applicable to various designs using various colors.

<Discrimination Image Generation Method>

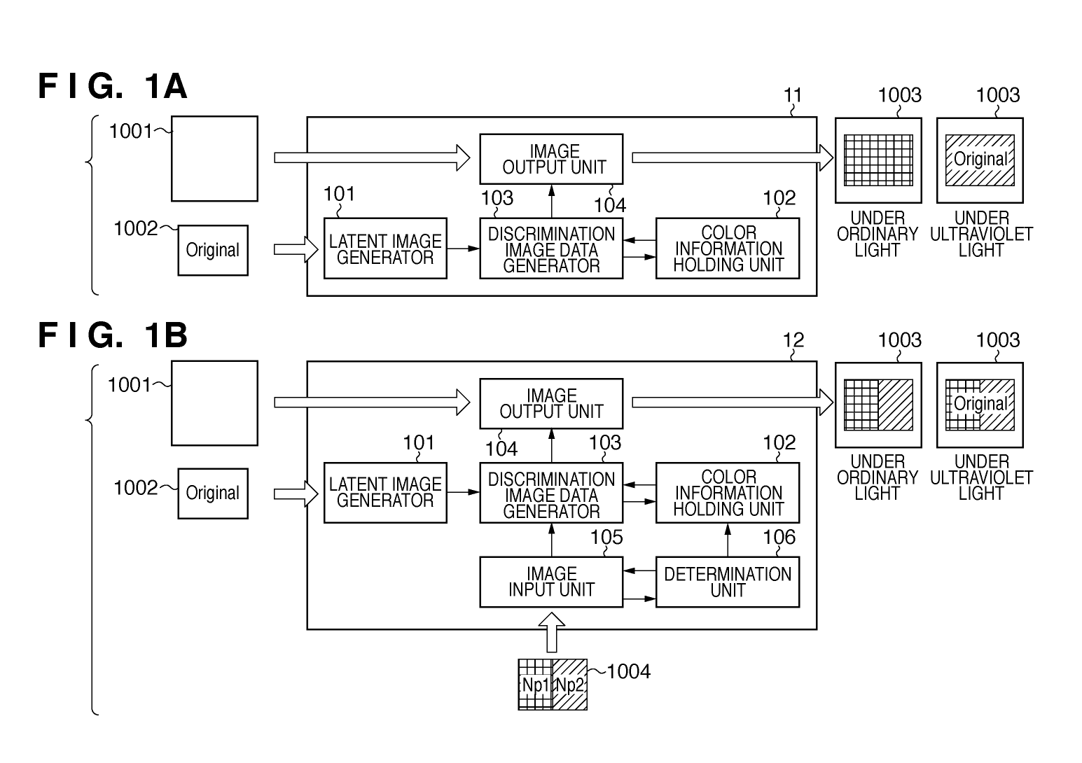

Next, particular processing of generating a discrimination image in an image processing apparatus having the color information generated by the above-described “color information generation method” will be described. FIG. 1A is a block diagram showing a functional configuration of the image processing apparatus according to the present embodiment. As shown in FIG. 1A, an image processing apparatus 11 in the present embodiment is capable of generating printed matter available for authenticity check. The image processing apparatus 11 has a latent image generator 101, a color information holding unit 102, a discrimination image data generator 103 and an image output unit 104.

The latent image generator 101 has a function of reading latent image data as electronic data and generating a latent image. The color information holding unit 102 has a function of holding color information on a first color and a second color requiring different ink use amounts per unit area with respect to some pixel value. The discrimination image data generator 103 has a function of generating data for formation of the discrimination image from the latent image and the color information. The image output unit 104 has a function of feeding paper and print-outputting the discrimination image based on the discrimination data on the paper.

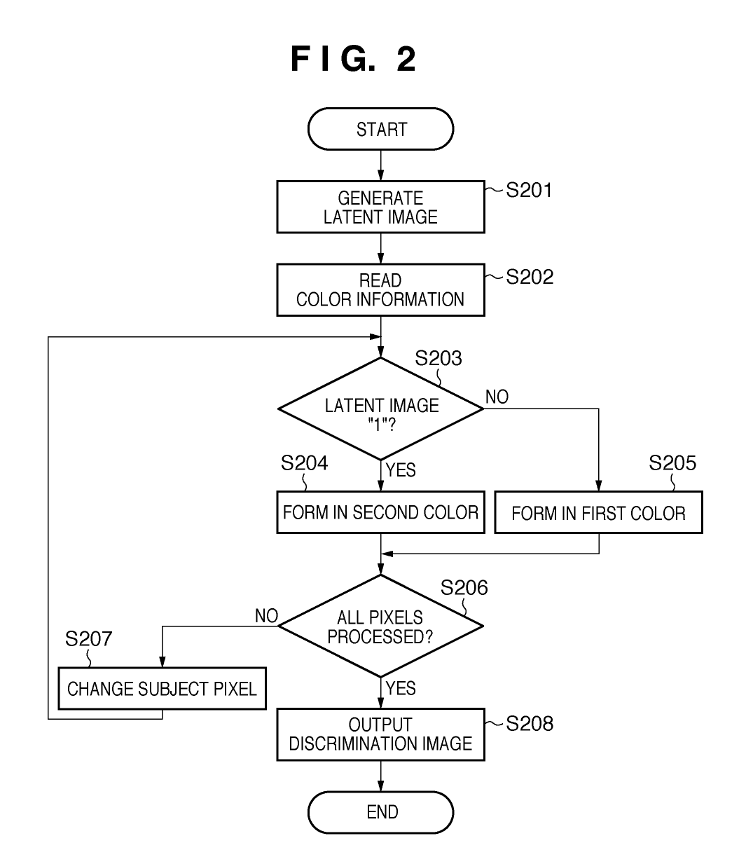

Hereinbelow, a method for realizing the present embodiment will be described in detail using the block diagram of FIG. 1A and the flowchart of FIG. 2.

First, the latent image generator 101 inputs discrimination subject information (hereinbelow, “latent image data C”) to be subjected to discrimination under ultraviolet light such as character(s), a mark or the like, generates latent image data Ic, and supplies the data to the discrimination image data generator 103 (step S201). Note that the latent image data Ic is binary image data which can be handled in pixel units, in which a pixel value of a character or mark portion is “1” and other pixel values are “0”. In other words, the latent image data Ic has information indicating whether each pixel belongs to the above-described first region or the second region.

In FIG. 1A, when the latent image data C indicates characters “Original” as denoted by reference numeral 1002, the latent image data Ic is binary image data where the pixel value in the region of the character is “1” while the pixel value other than the region of the character is “0”. Note that in this embodiment, when the latent image data C is a binary image, it is the latent image data Ic, however, when the latent image data C is drawing information to draw character(s) or a mark, a binary image is generated based on the drawing information as the latent image data Ic. In the following description, a discrimination image having the same size as that of the latent image data Ic is generated.

When the latent image data Ic is supplied from the latent image generator 101, the discrimination image data generator 103 accesses the information holding unit 102, and obtains color information Ci with respect to some pixel value Np (step S202). Note that in this embodiment, for the sake of simplicity of explanation, printing of a discrimination image is performed with respect to a predetermined one pixel value.

As shown in FIG. 8B, the color information holding unit 102 holds the color information Ci which is structural information indicating the color material and the amount of the color material for formation on paper with respect to the pixel value Np. As described in the aforementioned conception, the color information Ci has color information on the first color and color information on the second color in which ΔEab*≦Th1 holds as the color difference under ordinary light and ΔC_sum≧Th2 holds as the total difference in ink use amount, with respect to the pixel value of image data.

In this embodiment, as shown in FIG. 8B, the discrimination image data generator 103 obtains color information

Ci=(C1,C2)=((0,0,0,0,0,0,24),(11,27,0,0,0,0,0)) with respect to a pixel value Np2. Note that when there are plural pixel values Np, one pixel value to be used is designated. Upon that designation, candidates are displayed for a user and one of the candidates is designated.

The discrimination image data generator 103 obtains the color information Ci from the color information holding unit 102, then generates discrimination image data Itd as data forming a discrimination image from the latent image data It and the color information Ci, and supplies the generated data to the image output unit 104. The discrimination image data Itd is set data of color information with respect to each pixel. The generation of the discrimination image data Itd is, handling 1 pixel of the latent image data Ic as a subject pixel, execution of the following processing sequentially from an upper left corner pixel of the latent image data Ic by 1 pixel.

First, regarding the subject pixel of the latent image data Ic, it is determined whether or not the value of the subject pixel is “1”, i.e., a character or mark exists (step S203). When the value of the subject pixel is “1”, it is determined that the discrimination image data Itd is the second color C2 (11,27,0,0,0,0,0) (step S204). On the other hand, when the value of the subject pixel is “0”, it is determined that the discrimination image data Itd is the first color C1 (0,0,0,0,0,0,24) of the color information Ci (step S205). Hereinbelow, this processing is repeated.

Note that in this embodiment, the color of the character(s) or mark region is the second color and the color of the peripheral region is the first color, however, these colors may be exchanged. In such case, as the character(s) or mark is fluorescent in comparison with the peripheral region under ultraviolet light, the fluorescent region, if it is character(s), it can be recognized as outline character(s).

Then, it is determined whether or not the subject pixel processed as above is a final pixel (lower right corner pixel) (step S206). When it is determined that the subject pixel is not the final pixel, the subject pixel is changed (step S207) and the same processing is repeated from step S203 untill the final pixel is processed. In this manner, the discrimination image data Itd is generated with respect to all the pixels of the latent image data Ic. When the discrimination image data Itd is supplied from the discrimination image data generator 103, the image output unit 104 feeds paper 1001, print-outputs the discrimination image It from the discrimination image data Itd on the paper, and outputs printed matter 1003 on which the discrimination image It has been printed (step S208).

The processing of generating printed matter available for authenticity check is as described above using the functional diagram and the flowchart. According to the first embodiment, by performing the above-described processing on a print medium including a fluorescent brightening agent, printed matter available for authenticity check can be easily generated with ordinary ink.

### Second Embodiment

In the above-described first embodiment, a discrimination image is generated with respect to one pixel value, however, in some cases, a discrimination image is to be generated with respect to an image in plural colors such as a mark. Next, a modification of the first embodiment will be described as a second embodiment. In the embodiment, a method of printing a discrimination image based on an image formed with plural pixel values will be described.

FIG. 1B is a block diagram of the image processing apparatus according to the second embodiment. As shown in FIG. 1B, an image processing apparatus 12 is capable of generating printed matter formed with plural colors available for authenticity check. The image processing apparatus 12 has the latent image generator 101, the color information holding unit 102, the discrimination image data generator 103, the image output unit 104, an image input unit 105 and a determination unit 106. The image input unit 105 has a function of reading or generating image data as electronic data. The determination unit 106 has a function of determining whether or not color information on a pixel value of input image data is held in the color information holding unit 102.

Note that as the latent image generator 101, color information holding unit 102, the discrimination image data generator 103, and the image output unit 104 have the same functions as those of the latent image generator 101, the color information holding unit 102, the discrimination image data generator 103 and the image output unit 104 in the above-described first embodiment, the detailed explanations of these units will be omitted. Accordingly, in the image processing apparatus 12, the image input unit 105 and the determination unit 106 are added to the image processing apparatus 11 described in the first embodiment.

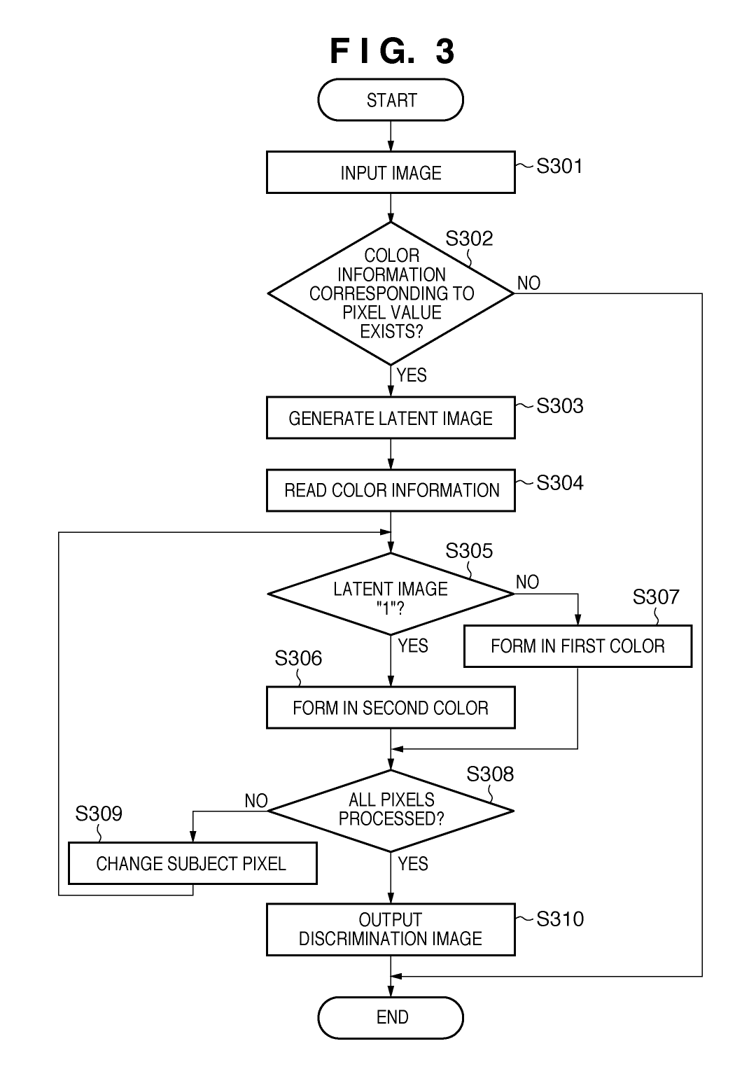

Hereinbelow, a method for realizing the present embodiment will be described in accordance with the block diagram of FIG. 1B and the flowchart of FIG. 3.

First, when image data 1004 is inputted into the image processing apparatus 12, the image input unit 105 reads the image, generates image data I as electronic data (step S301), and supplies the generated data to the determination unit 106. Note that the image data I is an image which can be handled in pixel units. For example, in a case where the image is formed on a paper document, on the presumption that the image input unit 105 has a charge coupled device (CCD) or an optical sensor, the image input unit 105 performs photographing on the image in accordance with an image input instruction, then performs electric signal processing, digital signal processing and the like, to generate the image data I. Further, the image is data described in page description language or data generated with an application handling a particular data format, the data format is converted to a general image format (bitmap format) or the like as the image data I. In this embodiment, for the sake of simplicity of explanation, the generated image data I has a region of a pixel value Np1 and a region of a pixel value Np2 as denoted by reference numeral 1004 in FIG. 1B.

Then, the determination unit 106 receives the image data I supplied from the image input unit 105, and determines whether or not color information on each pixel value of the image data I is held in the color information holding unit 102 (step S302). When it is determined that the color information is not held in the color information holding unit 102, the generation of discrimination image is not performed but the processing is terminated (error termination). When it is determined that the color information is held in the color information holding unit 102, the image data I is supplied to the discrimination image data generator 103.

Next, the latent image generator 101 inputs latent image data C representing character(s) or mark to be visualized under ultraviolet light, then generates latent image data Ic, and supplies the generated data to the discrimination image data generator 103 (step S303).

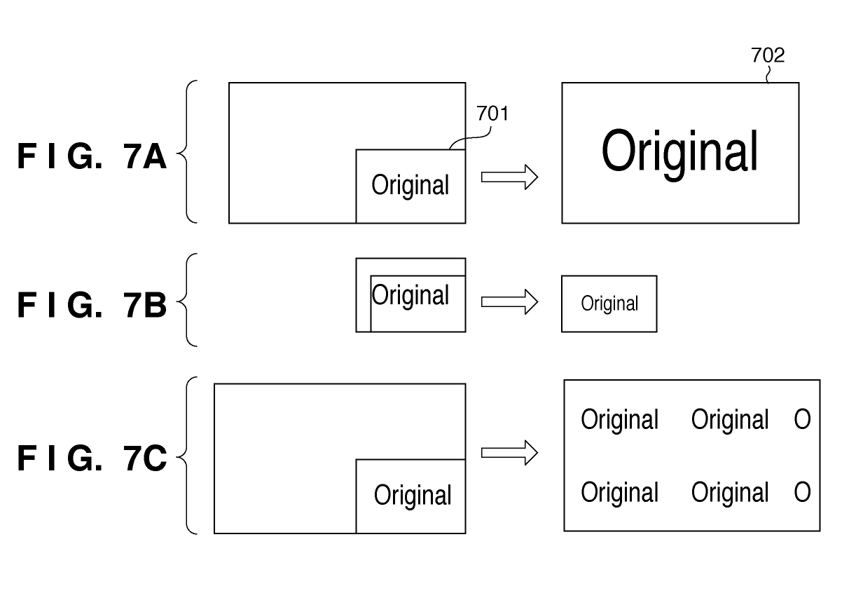

Note that in the first embodiment, the size of the discrimination image is the same as that of the latent image data Ic, however, in the second embodiment, the size of the discrimination image is the same as that of the input image data I. Accordingly, in some cases, the size of the image data I and that of the latent image data Ic are different. When the size of the latent image data Ic is smaller than that of the image data I, the latent image data Ic is generated by expanding the latent image data Ic as shown in FIG. 7A. Further, the latent image data Ic may be generated by repeating the the latent image data Ic as shown in FIG. 7C. When the size of the latent image data Ic is larger than that of the image data I, the the latent image data Ic is reduced as shown in FIG. 7B.

Then, the discrimination image data generator 103 obtains color information Ci with respect to the pixel values Np1 and Np2 while accessing the color information holding unit 102 (step S304). The discrimination image data generator 103 generates discrimination image data Itd as data forming the discrimination image from the latent image data Ic and the image data I, and supplies the generated data to the image output unit 104. The discrimination image data Itd is set data of color information on each pixel.

The generation of the discrimination image data Itd is made by, handling one pixel of the latent image data Ic and the image data I as a subject pixel, execution of the following processing sequentially from an upper left corner pixel of the latent image data Ic and the image data I by 1 pixel. Note that in this embodiment, the color information holding unit 102 holds the color information Ci with respect to the pixel values Np1 and Np2 as shown in FIG. 8C.

First, regarding the subject pixel of the latent image data Ic, it is determined whether or not the value of the subject pixel is “1”, i.e., a character or mark exists (step S305). When the value of the subject pixel is “1” and the pixel value of the image data I is Np1, C2 of the color information Ci1 with respect to the pixel value Np1 is obtained and it is determined that the discrimination image data Itd is the second color C2 (0,0,0,30,0,0,0) of the color information Ci1. When the value of the subject pixel is “1” and the pixel value of the image data I is Np2, C2 of the color information Ci2 with respect to the pixel value Np2 is obtained, and it is determined that the discrimination image data Itd is the second color C2 (11,27,0,0,0,0,0) of the color information Ci2 (step S306).

Further, when the value of the subject pixel is “0” and the pixel value of the image data I is Np1, C1 of the color information Ci1 with respect to the pixel value Np1 is obtained and it is determined that the discrimination image data Itd is the first color C1 (0,0,0,24,0,0,0) of the color information Ci1. When the value of the subject pixel is “0” and the pixel value of the image data I is Np2, C1 of the color information Ci2 with respect to the pixel value Np2 is obtained and it is determined that the discrimination image data Itd is the first color C1 (0,0,0,0,0,0,24) of the color information Ci2 (step S307).

Then, it is determined whether or not the subject pixel processed as above is a final pixel (step S308). When it is determined that the subject pixel is not the final pixel, the subject pixel is changed (step S309) and the same processing is repeated from step S305 untill the final pixel is processed.

In this manner, the discrimination image data Itd is generated with respect to all the pixels of the latent image data Ic.

Then, when the discrimination image data Itd is supplied from the discrimination image data generator 103, the image output unit 104 feeds paper 1001, print-outputs the discrimination image It from the discrimination image data Itd on the paper, and outputs printed matter 1003 on which the discrimination image It has been printed (step S310). Accordingly, when printing is performed on a print medium including a fluorescent brightening agent, it is possible to generate a discrimination image formed with plural colors on the print medium.

Note that in this embodiment, the processing is terminated when the color information with respect to each pixel value of the image data I is not held in the color information holding unit 102. However, it may be arranged such that in place of termination, the discrimination image is generated using color information on an approximate pixel value.

For example, assuming that color information as shown in FIG. 8D is held in the color information holding unit 102, and as a pixel value Np3 of the image data I, Np3=(R,G,B)=(128,0,250) holds, the determination unit 106 does not perform determination, but the discrimination image data generator 103 performs the following processing. The discrimination image data generator 103 generates the discrimination image data Itd, with the pixel value Np3 of the image data I as an approximate pixel value

Np1=(R,G,B)=(128,0,255), using the color information Ci1 of the pixel value Np1.

Further, it may be arranged such that the first color and the second color with respect to a pixel value of the image data I are calculated from the held color information. For example, assuming that as a pixel value Np4 of the image data I,

Np4=(R,G,B)=(128,0,224) holds, the discrimination image data generator 103 calculates color information with respect to the pixel value Np4 from the color information on the pixel values Np1 and Np2 held in the color information holding unit 102 using interpolation as a known technique. As the interpolation, liner interpolation, Lagrange's interpolation, Newton interpolation, Gauss' interpolation, Bessel's interpolation and the like can be used. As the result of calculation,
Ci4=(C1,C2)=((0,0,0,0,0,0,18),(9,21,0,0,0,0,0)) holds, thus the color information with respect to the pixel value Np4 is obtained.

### Third Embodiment

In the above-described second embodiment, the discrimination image It is generated based on the color information previously held in the color information holding unit 102. Hereinbelow, a modification of the above-described embodiment will be described as a third embodiment. In this embodiment, an image having plural pixel values is handled as an input image, and with respect to each pixel value of the input image, color information on the first color and the second color with different ink use amounts per unit area are generated, and a discrimination image is print-outputted based on the color information.

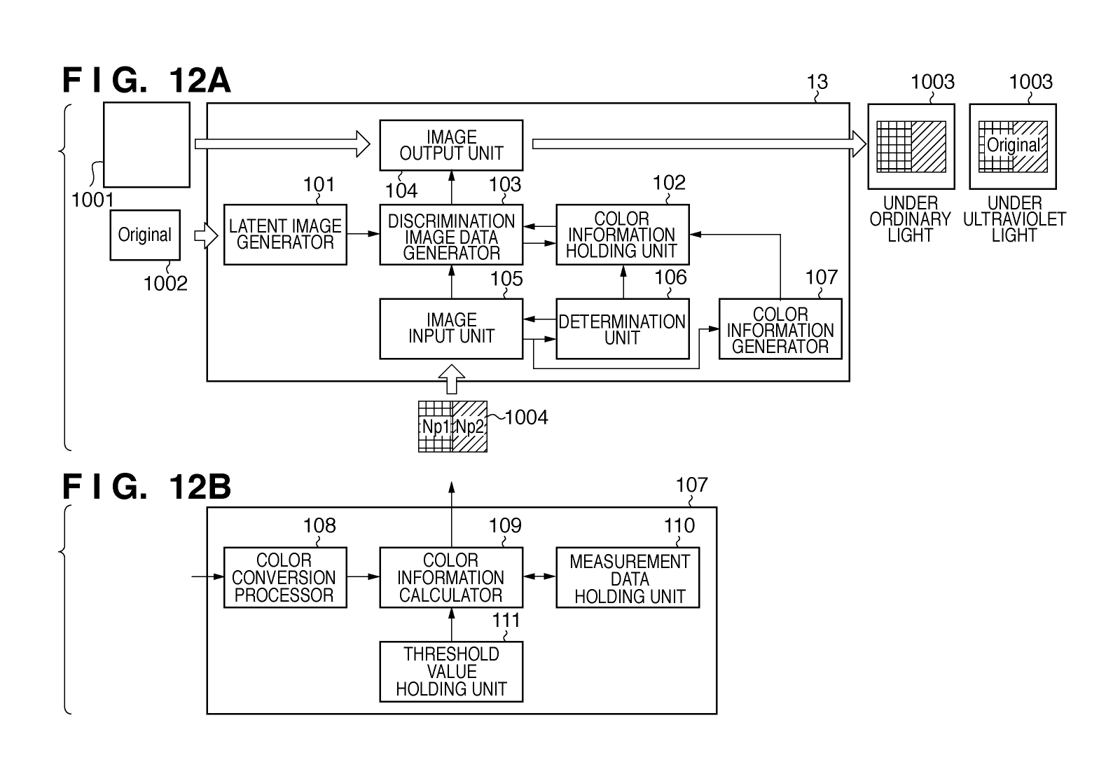

FIG. 12A is a block diagram of an image processing apparatus 13 in the present third embodiment. As shown in FIG. 12A, the image processing apparatus 13 is capable of generating printed matter formed with plural colors available for authenticity check. The image processing apparatus 13 has the latent image generator 101, the color information holding unit 102, the discrimination image data generator 103, the image output unit 104, the image input unit 105, the determination unit 106 and a color information generator 107. The color information generator 107 has a function of generating color information on the first color and the second color with different ink use amounts per unit area with respect to a pixel value of an input image. In the present embodiment, different inks are used for the first color and the second color.

Note that as the latent image generator 101, the color information holding unit 102, the discrimination image data generator 103, the image output unit 104, the image input unit 105 and the determination unit 106 have the same functions as those of the latent image generator 101, the color information holding unit 102, the discrimination image data generator 103, the image output unit 104, the image input unit 105 and the determination unit 106 in the above-described second embodiment, the detailed explanations of these units will be omitted. Accordingly, in the image processing apparatus 13, color information generator 107 is added to the image processing apparatus 12 described in the second embodiment.

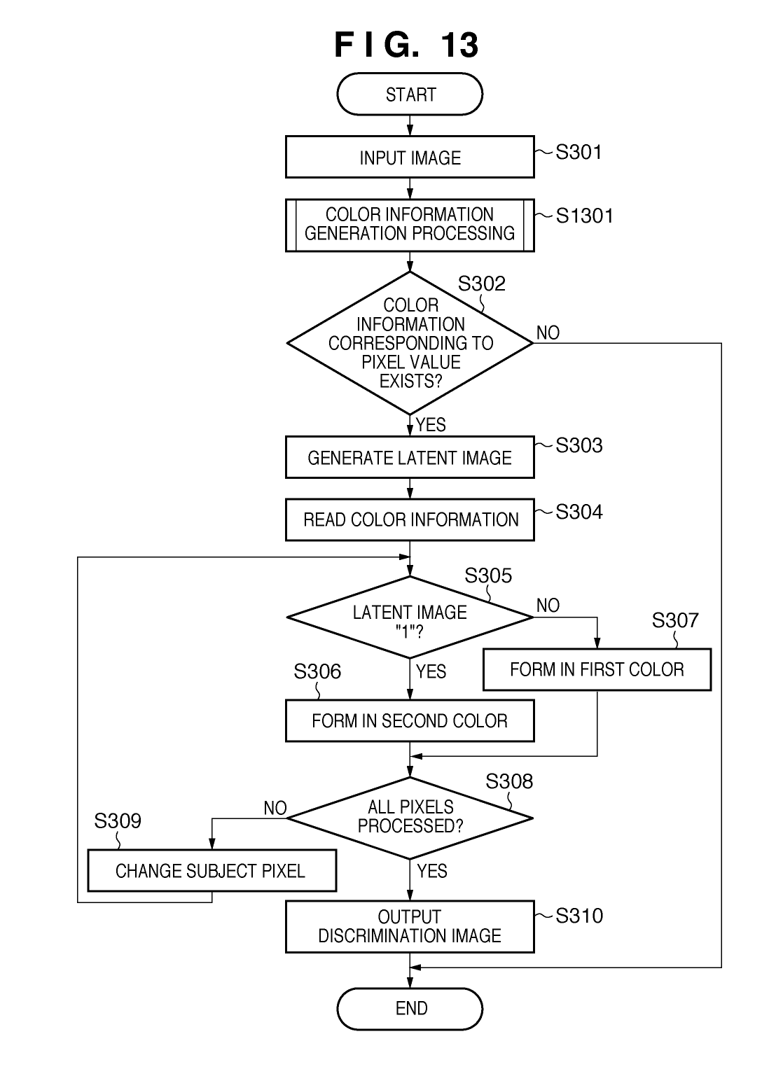

Hereinbelow, a method for realizing the present third embodiment will be described in accordance with the block diagram of FIG. 12A and the flowchart of FIG. 13.

First, when the image data 1004 is inputted into the image processing apparatus 13, the image input unit 105 reads the image, generates image data I as electronic data (step S301), and supplies the generated data to the color information generator 107.

Then, the color information generator 107 receives the image data I supplied from the image input unit 105, generates color information with respect to each pixel of the image data I, supplies the generated information to the color information holding unit 102, and the color information holding unit 102 holds the information (step S1301).

Hereinbelow, as the processing of generating the discrimination image data Itd based on the color information held in the color information holding unit 102 (steps S302 to S310) is the same as the processing (steps S302 to S310) described in the second embodiment, the detailed explanation of the processing will be omitted. Accordingly, in the generation processing in the third embodiment, the color information generation processing (S1301) is added to the generation processing described in the above second embodiment.

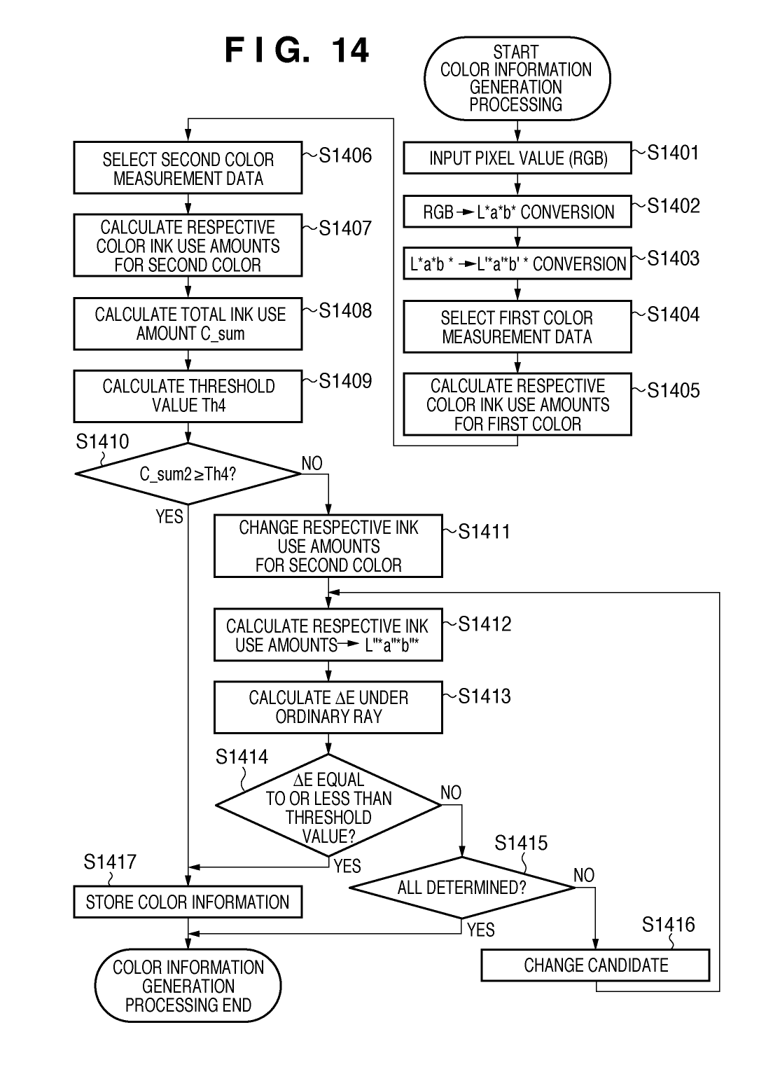

Hereinbelow, the above-described color information generation processing (S1301) will be described in more detail in accordance with the block diagram of FIG. 12B and the flowchart of FIG. 14.

The color information generator 107, with the function of generating the color information on the first color and the second color with different ink use amounts per unit area with respect to a pixel of an input image, has a color conversion processor 108, a color information calculator 109, a measurement data holding unit 110 and a threshold value holding unit 111. The color conversion processor 108 has a function of converting a pixel value of the image data I to color space data representable on a device. The color information calculator 109 has a function of calculating the color information on the first color and the second color. The measurement data holding unit 110 has a function of holding L*a*b* values with respect to ink use amounts as color measurement data, and a covering ratio with respect to the total ink use amount, as covering ratio data. The threshold value holding unit 111 has a function of holding a threshold value of discrimination of color difference under ordinary light as Th1, and a threshold value of covering ratio difference to cause luminance difference under ultraviolet light, as Th3.

First, when the pixel value Np1 of the image data I is inputted (S1401), the color conversion processor 108 converts the pixel value into L*a*b* values as device-independent color space values (step S1402), and converts the obtained L*a*b* values to L′*a′*b′* values as device-dependent color space values (step S1403). This means converting the pixel value of the image data I into common color space data and converting from the common color space data into device-representable color space data, thereby converting the colors of the image data I into colors which can be outputted by the image output unit 104. Then the color conversion processor 108 supplies the converted L′*a′*b′* to the color information calculator 109.

The color information calculator 109 calculates the first color C1(c,m,y) and the second color C2(r,g,b) as respective ink use amounts with respect to the supplied L′*a′*b′* values, using the color measurement data held in the measurement data holding unit 110.

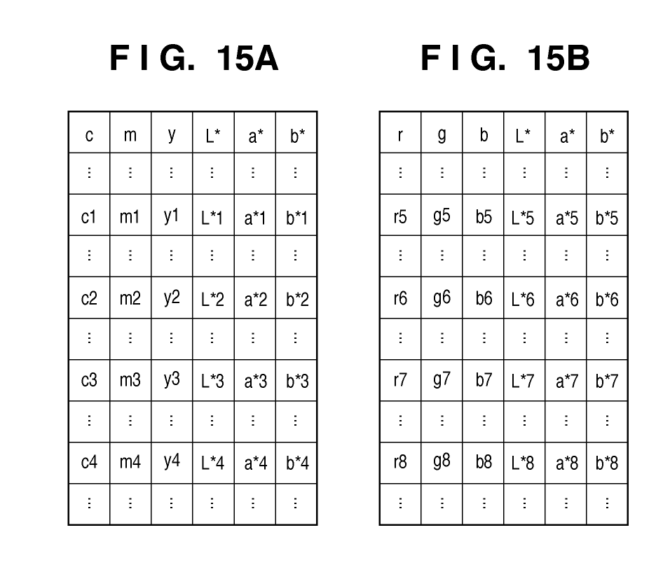

Note that as shown in FIGS. 15A and 15B, the measurement data holding unit 110 holds the L*a*b* values with respect to ink use amounts as color measurement data in a table. The L*a*b* values are numerical values obtained by printing plural measurement patches with various ink use amounts and measuring the printed patches in an environment of irradiation with ordinary light.

FIG. 15A shows L*a*b* values with respect to CMY ink use amounts. FIG. 15B shows L*a*b* values with respect to RGB ink use amounts. In the present embodiment, as different inks are used for the first color and the second color, the color measurement data in FIG. 15A is used for calculation of the first color, and the color measurement data in FIG. 15B is used for calculation of the second color. Note that when the same ink is used for the first color and the second color, one of the color measurement data in FIGS. 15A and 15B may be used.

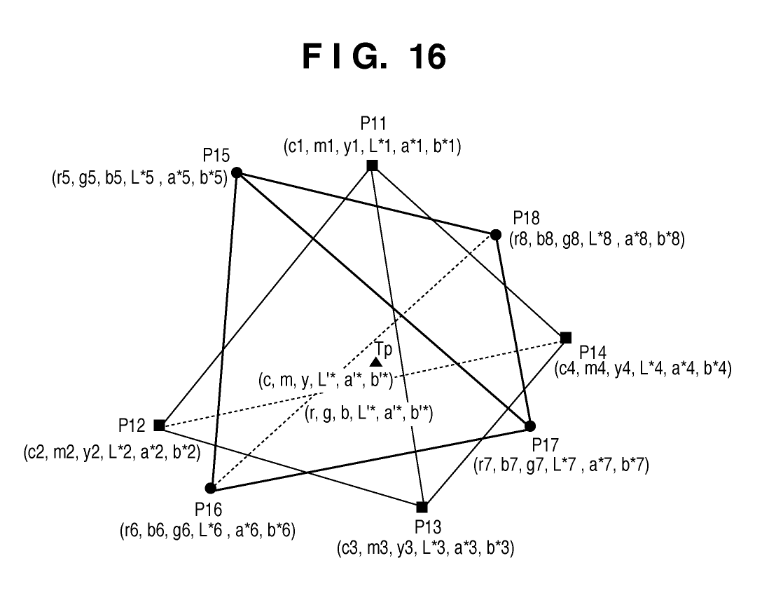

More particularly, four data having L*a*b* values close to the L′*a′*b′* values are obtained from the first color measurement data (FIG. 15A) in the measurement data holding unit 110 (step S1404), and from the obtained data, respective ink use amounts corresponding to the L′*a′*b′* values, i.e., the first color C1 (c,m,y), are calculated by interpolation as a known technique (step S1405). Note that FIG. 16 shows the four data represented in the L*a*b space. In FIG. 16, (c,m,y) as Tp(L′*a′*b′) can be calculated from the four data P11, P12, P13 and P14.

Similarly, four data having L*a*b* values close to the L′*a′*b′* values are obtained from the second color measurement data (FIG. 15B) in the measurement data holding unit 110 (step S1406), and from the obtained data, respective ink use amounts corresponding to the L′*a′*b′* values, i.e., the second color C2, are calculated (step S1407). In FIG. 16, (r,g,b) as Tb(L′*a′*b′*)can be calculated from the four data P15, P16, P17 and P18.

Next, the total ink use amount C_sum is respectively calculated from the first color C1 and the second color C2 (step S1408). The total ink use amount is a value obtained by adding the respective ink use amount. For example, when the first color C1 values are (20,0,10) and the second color C2 values are (5,30,5), the total of the respective ink use amounts for the first color C1, C_sum1, is 30, and the total of the respective ink use amounts for the second color C2, C_sum2, is 40.

Next, the threshold value Th4 as a threshold value of the total ink use amount C_sum2 for the second color C2 is calculated (step S1409) from the total ink use amount C_sum1 for the first color C1, the threshold value Th3 held in the threshold value holding unit 111 and the covering ratio data held in the measurement data holding unit 110. This is calculation of the total ink use amount for the second color C2 when the difference in covering ratio with respect to the first color C1 is Th3. Note that as shown in FIG. 17, the covering ratio data is a table indicating covering ratios with respect to total ink use amounts. The covering ratio is a numerical value obtained by printing plural measurement patches with various ink use amounts and measuring the printed patches. Note that the ink use amount and the covering ratio are not in proportional relation. Generally, when the ink use amount is small per unit area, due to influence of ink blur, the increasing rate of the covering ratio is increased. Then, as the ink use amount per unit area increases, by the influence of overlapped ink discharge, the increasing rate of the covering ratio is converged.

Next, processing of obtaining the covering ratio cov from the total ink use amount C_sum is expressed as follows.

cov=f1(C_sum)

Further, processing of obtaining the total ink use amount C_sum from the covering ratio cov is expressed as follows.

C_sum=f2(cov)

In the above-described example, as the total ink use amount for the first color C1, C_sum1=30 holds, from the covering data in FIG. 17, as the covering ratio cov1 for the first color C1, cov1=f1(C_sum1)=f1(30)=45 holds. When Th3=15 holds as the threshold value Th3 for the difference in covering ratio regarding occurrence of luminance difference under ultraviolet light, it is sufficient that the difference between the covering ratio for the first color C1 and the covering ratio for the second color C2 is 15. Accordingly, it is sufficient that as the covering ratio cov2 for the second color C2, cov2=cov1+Th3=45+15=60 holds. At this time, as the total ink use amount, C_sum2=f2(cov2)=f2(60)=40 holds. Accordingly, the threshold value Th4 of the total ink use amount C_sum2 for the second color C2 is 40.

Then, it is determined whether or not the total ink use amount C_sum2 calculated at step S1408 is equal to or greater than Th4 (step S1410).

When it is determined that the total ink use amount C_sum2 is equal to or greater than Th4, the first color C1 and the second color C2 are supplied, as the color information Ci, to the color information holding unit 102. The color information holding unit 102 holds the supplied color information as the color information Ci1 with respect to the pixel value Np1 (step S1417). In this case, as the total ink use amount C_sum2 is equal to or greater than Th4, colors C1=(20,0,10) and C2=(5,30,5) are held as the color information Ci1 for the pixel value Np1 in the information holding unit 102.

On the other hand, when the total ink use amount C_sum2 is less than Th4, the respective ink use amounts for the second color C2 are changed such that the total ink use amount C_sum2 is equal to or greater than Th4 (step S1411).

For example, when the first color C1 is (10,10,10), the second color C2, (12,12,12) and Th3=15 holds as Th3, as the total ink use amount C_sum1 is 30 and the total ink use amount C_sum2 is 36, i.e., the total ink use amount C_sum2 is less than Th4=40. Accordingly, the respective ink use amounts are changed such that the total ink use amount C_sum2 is equal to or greater than Th4=40, i.e., the total of ink use amounts for the second color C2 is equal to or greater than 40, as a second color C2′. As candidates for the second color C2′, (14,13,13), (13,14,13), (13,13,14) or the like can be given. Note that as long as the total ink use amount is equal to or greater than 40, may other candidate can be given. However, when the amount of change is increased, the color difference ΔE with respect to the first color C1 to be calculated later becomes greater. It is desirable that the amount of change is as small as possible. Accordingly, an upper limit of the amount of change is determined, and plural candidates with ink use amounts not beyond the upper limit are calculated in advance.

Next, the L*a*b* values for the second color C2′ changed such that the total ink use amount is equal to or greater than the threshold value Th4 are calculated (step S1412). More particularly, four data with printing color materials close to the changed second color C2′ are obtained from the second color measurement data in the measurement data holding unit 110, and the L*a*b* values for the changed second color C2′ are calculated from the obtained data by interpolation as a known technicue. Then a color difference ΔE between the calculated L*a*b* values for the second color C2′ and the L′*a′*b′* values calculated by the color conversion processor 108 is calculated (step S1413). Then, it is determined whether or not the obtained color difference ΔE is equal to or less than the threshold value Th1 (step S1414). The determination is made as to whether or not the color difference between the first color and the second color is at an undiscriminable level since the L*a*b* values under ordinary light are changed by the change of the respective ink use amounts for the second color C2.

When it is determined that the obtained color difference ΔE is equal to or less than the threshold value Th1, the first color C1 and the second color C2′ are supplied as the color information Ci to the color information holding unit 102. The color information holding unit 102 holds the information as the color information Ci1 with respect to the pixel value Np1 (step S1417).

Further, when it is determined that the obtained color difference ΔE is greater than the threshold value Th1, it is determined whether or not determination of all the candidates for the second color C2′ for which the respective ink use amounts are changed has been completed (step S1415). When it is not determined that the determination of all the candidates has not completed, the candidate is changed (step S1416), and the processing at step S1314 and the subsequent steps is performed. Note that when it is determined at step S1415 that the determination for all the candidates has been completed, the processing is terminated (error-termination).

In this manner, the color information Ci for the first color and the second color, indicating different ink use amounts per unit area with respect to a pixel value of an input image, is generated.

Note that when the threshold value Th3 in the above example is 15, as the covering ratio cov2 of the second color C2, cov2=cov1+Th3=45+15=60 holds. That is, the covering ratio of the second color C2 is higher than the covering ratio of the first color C1. However, as long as the difference between the covering ratio of the first color C1 and the covering ratio of the second color C2 is 15, as the covering ratio cov2 of the second color C2, cov2=cov1−Th3=45−15=30 may be used. That is, the present invention is applicable to a case where the covering ratio of the second color C2 is lower than the covering ratio of the first color C1. In this case, as the total ink use amount C_sum2 for the second color C2, C sum2=f2(cov2)=f2(30)=20 holds, as the threshold value Th4, Th4=20 holds. Then the determination as to whether or not the total ink use amount C_sum2 is less than the threshold value Th4 is performed. When it is determined that the total ink use amount C_sum2 is equal to or greater than the threshold value Th4, the respective ink use amounts for the second color C2 are changed such that the total ink use amount is less than the threshold value Th4.

### Fourth Embodiment

Hereinbelow, as a fourth embodiment, an example where the processing according to the above-described respective embodiments is realized with a computer program (application program and a printer driver program) executed by an information processing apparatus such as a personal computer connected to a printer will be described. For the sake of simplicity of explanation, the fourth embodiment is applied to the first embodiment, however, those skilled in the art easily understand that the forth embodiment is also applicable to other embodiments.

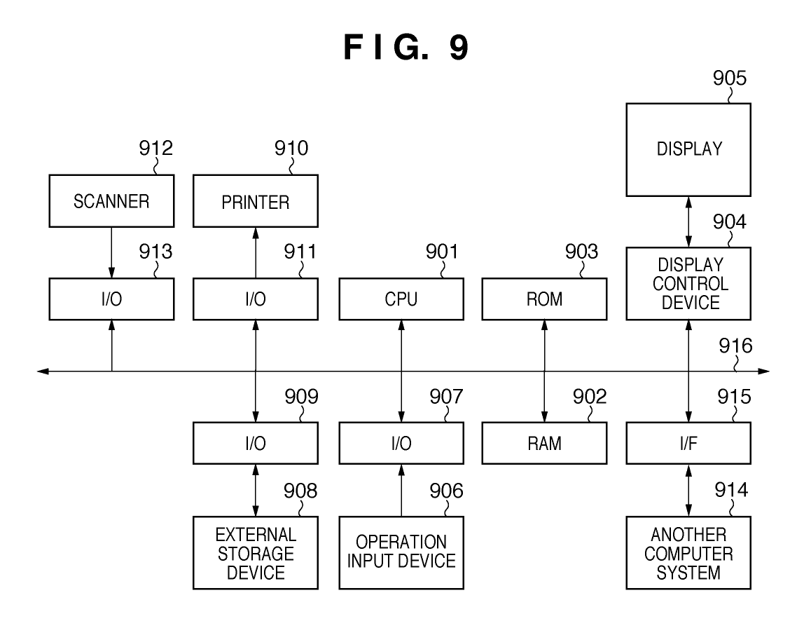

FIG. 9 shows a basic configuration of a computer. In FIG. 9, a CPU 901 controls the entire computer and performs the respective processings described in the above embodiments using programs and data stored in a RAM 902 or a ROM 903. The RAM 902 has an area for temporary storage of programs and data loaded from the external storage device 908, or programs and data downloaded from another computer system 914 via an I/F (interface) 915. The RAM 902 further has an area necessary for the CPU 901 to perform various processing. The ROM 903 holds functional programs and setting data and the like of the computer. Numeral 904 denotes a display control device to perform control processing for display of images, characters and the like on a display 905. The display 905 displays images, characters and the like. Note that as the display, a CRT, a liquid crystal display screen or the like is applicable. Numeral 906 denotes an operation input device having devices such as a keyboard and a mouse to input various instructions into the CPU 901. Numeral 907 denotes an I/O to notify various instructions and the like inputted via the operation input device 906 to the CPU 901. Numeral 908 denotes an external storage device which functions as a large capacity information storage such as a hard disk to hold an OS (operating system), programs for execution of the processings according to the above-described respective embodiments by the CPU 901, input/output original images and the like. The writing/reading of information into/from the external storage device 908 is performed via an I/O 909. Numeral 910 denotes a printer to output documents and images. Note that as a printer to output documents and images, an ink-jet printer, a laser beam printer, a thermal transfer printer, a dot impact printer or the like can be given. Numeral 912 denotes a scanner to read a document or image which sends input data via an I/F 913 to the RAM 902 or the external storage device 908. Numeral 916 denotes a bus interconnecting the CPU 901, the ROM 903, the RAM 902, the I/O 911, the I/O 909, the display control device 904, the I/F 915, the I/F 907 and the I/F 913.

In the above configuration, when the power of the apparatus main body is turned ON, the CPU 901 reads the OS from the external storage device 908 to the RAM 902 and executes the OS in accordance with a boot program stored in the ROM 903. As a result, the apparatus functions as an information processing apparatus using the operation input device 906 and the display 905 as a user interface. When a user instructs to execute an application described below, the present apparatus functions as an information processing apparatus. Then the user can perform various applications installed in the external storage device 908.

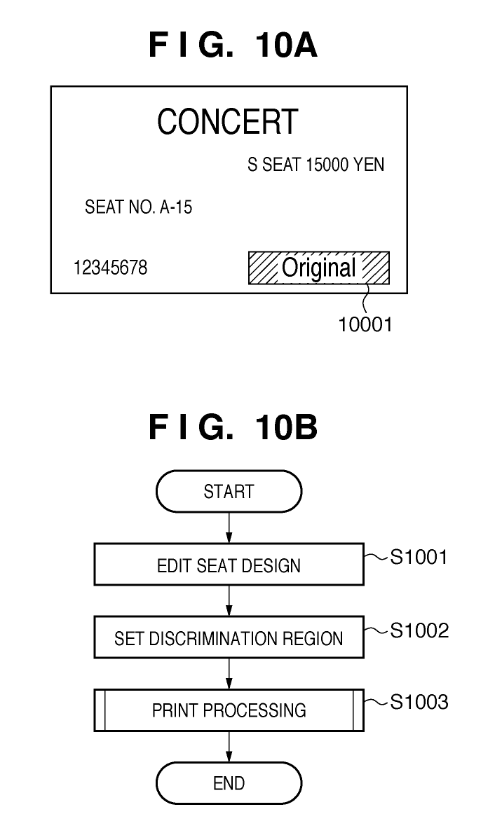

For assistance of understanding, in this embodiment, an application program to design a concert ticket and print-output the designed ticket will be described. FIG. 10A shows an example of the ticket design. It is presumed that a print sheet as a mother body of this ticket sufficiently includes a fluorescent brightening agent. As shown in FIG. 10A, when the user performs designing of the ticket by execution of the application program, the user defines its background, a concert name, a price, a seat number, a serial number and the like, and in addition, as shown in FIG. 10A, the user sets a discrimination region 10001. Then the user sets a binary image (including a character string, a mark or the like) in the discrimination region 10001. A character string can be inputted from the keyboard, and as a mark or the like, a file previously generated with an application for generating an appropriate binary image can be designated.

Note that the application program in the fourth embodiment, it is possible to communicate with the installed printer driver or to access data managed by the printer driver via the OS (operating system). As a result, the application program can obtain a color table, available for generation of a discrimination image such as images shown in FIGS. 8A to 8D specialized for the printer 910 connected to the present apparatus, from the printer driver. As it is apparent from the already-described first and second embodiments, whether the number of pairs of the {first color and second color} in the color table is only one or more depends on the connected printer. When the user sets the discrimination region 10001 during editing of the ticket design, the application program (more exactly, the CPU executing the application program) indicates colors corresponding to the first color (or second color) in the respective {first color and second color} pairs in the color tale as a candidate, to prompt the user to select one. When the user instructs to perform printing, the application program sends the data indicating the designed ticket to the printer driver. At this time, regarding the discrimination region 10001, the application program delivers the position and size of the determination region, the selected color, and a character string (including font and size information) or mark as a discrimination image included in the determination region, in a particular command format, to the printer driver.

FIG. 10B is a flowchart showing a processing procedure of the application program in the fourth embodiment. Upon reception of an instruction to execute the present application, the CPU 901 loads the application program from the external storage device 908 to the RAM 902, and executes the application program. As a result, the CPU 901 performs the following processing according to the application program.

First, in response to the user's operation, the CPU 901 generates a ticket design in accordance with various figure variables and image editing functions in the application (step S1001). Next, in response to the user's instruction, the CPU 901 performs processing of setting the discrimination image region in the application (step S1002). The setting of the discrimination image region includes inputting the position and size of the region, a character string or mark as the original of latent image data C included in the region, and selecting a color used in the discrimination image region. As described above, as the color selection depends on the connected printer 910, the user selects a color from color information (first color) available for generation of a latent image obtained from the printer driver. Thereafter, when the user has designated the number of print copies and instructed to perform printing, the CPU 901 performs processing for delivery of the information on the ticket design and the setting information of the discrimination image region to the printer driver (step S1003).

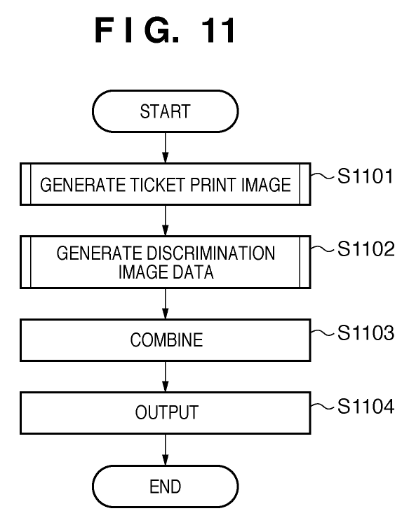

FIG. 11 is a flowchart showing a processing procedure in the printer driver executed by the CPU 901 in the present embodiment.

First, the CPU 901 generates ticket print image data in accordance with the ticket design information delivered from the application (step S1101). Next, the CPU 901 generates discrimination image data in accordance with the setting information of the discrimination image region delivered from the application (step S1102). The generation of the discrimination image data is realized by executing a program equivalent to the latent image generator 101, the color information holding unit 102 and the discrimination image data generator 103 in FIG. 1. Next, the CPU 901 combines the generated discrimination image data in the ticket print image in a position designated with the setting information of the discrimination image (step S1103), and repeats processing of outputting print image data obtained by the combining as print data toward the printer 910, by the designated number of copies (step S1104).

Note that in the above-described first to fourth embodiments, the print medium including fluorescent brightening agent which becomes fluorescent under ultraviolet light has been described, however, the present invention is not limited to this type of print medium as long as a part with a different ink covering ratio can be intentionally generated with respect to a print medium which becomes fluorescent under a particular light source. Accordingly, the fluorescent agent is not limited to the fluorescent brightening agent, and the light source is not limited to the ultraviolet light source. Further, the print medium may be a print medium including the fluorescent agent or may be a print medium coated with the fluorescent agent.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-241889 filed Oct. 20, 2009 and No. 2010-168428 filed Jul. 27, 2010, which are hereby incorporated by reference herein in their entirety.

What is claimed is:

1. An image processing apparatus for outputting print image data to a printing device which performs printing by attaching ink to a print medium, comprising:
a color information holding unit configured to hold first color information and second color information indicating different ink use amounts in said printing device per unit area on the print medium, and a color difference under ordinary light equal to or less than a predetermined threshold value;
an input unit configured to input discrimination subject information;
a generation unit configured to generate binary latent image data in accordance with the input discrimination subject information; and
an output unit configured to, in correspondence with a value of each pixel of said latent image data generated by said generation unit, output one of said first color information and said second color information held in said color information holding unit, as print data with respect to the pixel, to said printing device.

2. An image processing apparatus for outputting print image data to a printing device which performs printing by attaching ink to a print medium, comprising:
a color information generation unit configured to generate first color information and second color information indicating different ink use amounts in said printing device per unit area on the print medium, and a color difference under ordinary light equal to or less than a predetermined threshold value;
a color information holding unit configured to hold the color information generated by said color information generation unit;
an input unit configured to input discrimination subject information;
a generation unit configured to generate binary latent image data in accordance with the input discrimination subject information; and
an output unit configured to, in correspondence with a value of each pixel of said latent image data generated by said generation unit, output one of said first color information and said second color information held in said color information holding unit, as print data with respect to the pixel, to said printing device.

3. The apparatus according to claim 2, wherein said color information generation unit generates said first color information and said second color information using data indicating a covering ratio with respect to an ink use amount.

4. The apparatus according to claim 1, wherein a plurality of combinations of said first color information and said second color information are held in said color information holding unit.

5. The apparatus according to claim 1, wherein said print medium includes a fluorescent agent which becomes fluorescent under a particular light source or said print medium is coated with the fluorescent agent.

6. A control method for an image processing apparatus, having a color information holding unit configured to hold first color information and second color information indicating different ink use amounts in a printing device per unit area on a print medium, wherein a color difference under ordinary light being equal to or less than a predetermined threshold value, for outputting print image data to said printing device, comprising:
an input step of inputting discrimination subject information;
a generation step of generating binary latent image data in accordance with the input discrimination subject information; and
an output step of, in correspondence with a value of each pixel of said latent image data generated in said generation step, outputting one of said first color information and said second color information held in said color information holding unit as print data with respect to the pixel to said printing device.

7. A computer-readable storage medium holding a computer program, read and executed by a computer, thereby causes said computer to function as the image processing apparatus in claim 1.
